(19) United States
(12) Patent Application Publication
(10) Pub. No.: US 2013/0184386 A1
(43) Pub. Date: Jul. 18, 2013

(54) PLASTICIZING OF ALIPHATIC POLYESTERS WITH ALKYL ESTERS OF DIANHYDROHEXITOLS

(71) Applicants: Laurie Coudyser, Raismes (FR); Philippe Sabre, Saint Jans Cappel (FR)

(72) Inventors: Laurie Coudyser, Raismes (FR); Philippe Sabre, Saint Jans Cappel (FR)

(73) Assignee: ROQUETTE FRERES, Lestrem (FR)

(21) Appl. No.: 13/824,604

(22) PCT Filed: Oct. 7, 2011
(86) PCT No.: PCT/FR2011/052353

§ 371 Date: Mar. 18, 2013

(30) Foreign Application Priority Data
Oct. 8, 2010 (FR) 10 58202

(51) Int. Cl. C08K 5/12; C08K 5/11

(52) U.S. Cl. CPC C08K 5/12; C08K 5/11
USPC 524/109; 524/296; 524/314; 524/295

(57) ABSTRACT

A composition includes: at least one aliphatic or semi-aliphatic polyester containing at least 70 mol % of saturated aliphatic units, whereby the units can be obtained by polycondensation of monomers selected from among saturated hydroxyalkanoic acids having formula HO—CₓH₂ₓ—COOH, saturated dicarboxylic acids having formula HOOC—CₓH₂ₓ—COOH, and saturated diols having formula HO—CₓH₂ₓ—OH, wherein x=1-20, preferably 1-6, the rest of the units being formed by aromatic units; and at least one alkyl ester of 1,4:3,6-dianhydro hexitol selected from among alkyl monoesters and alkyl diesters of isosorbide, isomannide and isoidide. A a method for producing one such composition and to the different uses of one such composition are also described.

A subject matter of the invention is an aliphatic or semi-aliphatic polyester composition plasticized by a specific diol ester. Another subject matter of the invention is a process for manufacturing said composition and uses of this composition. Another subject matter of the invention is the use of this diol ester as plasticizer for an aliphatic or semi-aliphatic polyester.

The use of plastics has become widespread in numerous applications. The amounts of plastic which are produced and used worldwide have thus significantly increased in recent years, resulting in an increase in the volume of waste and in environmental problems.

In order to facilitate the removal of this plastic waste, biodegradable polymers are forming the subject of very particular interest. Mention may be made, as an example of biodegradable polymer, of “biodegradable polyethylene”, which is in reality composed of non-biodegradable polyethylene and of an additive which makes it possible to render it biodegradable.

These advantageous polymers also include aliphatic or semi-aliphatic polymers which, by virtue of their specific structure, exhibit an intrinsic biodegradable nature even in the absence of an additive.

The term “semi-aliphatic polyester” is understood to mean any polyester comprising at least 70 mol % of aliphatic units, that is to say of units devoid of an aromatic ring.

The term “aliphatic polyester” is understood to mean any polyester exclusively composed of aliphatic units.

The term “unit” in a polyester is understood to mean any unit which can be obtained by polycondensation of monomers forming polyesters, namely monomers chosen from dicarboxylic acids, diols and hydroxy acids.

By way of example, poly(lactic acid) (PLA), poly(glycolic acid) (PGA) and polycaprolactone (PCL) are aliphatic polyesters resulting from hydroxyalkanoic acid. Mention may be made, as polyester obtained by polycondensation of a diol and of a dicarboxylic acid, of poly(butylene succinate) (PBS), which is an aliphatic polyester, or also of poly(butylene adipate-co-terephthalate) (PBAT), which is a semi-aliphatic polyester resulting from the polycondensation of butanediol, of an aliphatic dicarboxylic acid (adipic acid) and of an aromatic dicarboxylic acid (terephthalic acid).

However, these polyesters can exhibit a number of disadvantages. In particular, their mechanical properties may be insufficient for certain uses. For example, PLA, in particular highly crystalline PLA, exhibits a very low elongation at break at ambient temperature (of the order of a few percent only) and is thus very brittle. In order to be able to use them in more numerous applications, it is necessary to improve the properties of these polyesters. For this, these polyesters can be blended with “plasticizers”.

The term “plasticizer” is understood to mean any product which, when it is mixed in a sufficient amount with a polymer, has the role of reducing the glass transition temperature of said polymer.

By reducing the glass transition temperature of the polymer, the flexibility of the latter is increased and the mechanical properties of this plasticized polymer are modified. Thus, on adding, to a polymer composition, a plasticizer for the latter, a decrease in the Young's modulus, a decrease in the tensile strength and/or an increase in the strain at break are generally observed. These modified properties of the polymer make it possible for it to be used in more numerous applications, for example in flexible films.

However, a plasticizer used for a certain type of polymer is not necessarily suitable for another type of polymer.

Mention may be made, by way of example, of the document EP0523789 A1, which describes plasticization tests on PLA with numerous known plasticizers. Glycerol trioleate, glycerol decanoate, propylene glycol, glycerol trihexanoate, glycerol, triacetin, lactates and citrates, which are known plasticizers for polyvinyl chloride (PVC), do not or insufficiently plasticize PLA, are not compatible with PLA or have an insufficient plasticizing effect.

Reference may also be made to chapter 11 of the Handbook of Plasticizers (Wypych G., ChemTec Publishing, 2004, pages 273-379), which specifies the plasticizers which can be used according to each type of polymer; these appropriate plasticizers are different according to the polymer targeted.

The effect of the plasticization of PLA on the mechanical properties has also been studied by Jocobsen et al. in the paper Plasticizing polylactide-the effect of different plasticizers on the mechanical properties (Polymer Engineering and Science, 1999, Vol. 39, No. 7, pages 1303-1310). A polyethylene glycol, a partially esterified fatty acid or a glucose monoester are introduced into the PLA in amounts by weight of less than or equal to 10%. Polyethylene glycol is the most efficient plasticizer. The plasticization of the PLA remains insufficient, as is shown by the very low elongation at break values.

Various citrates are also evaluated as plasticizer in PLA by Labrecque et al. in the paper Citrate Esters as Plasticizers for Poly(lactic acid) (Journal of Applied Polymer Science, 1997, Vol. 66, No. 8, pages 1507-1513). No cyclic diol ester is described as plasticizer in this document. Furthermore, these esters are not very stable thermally and exhibit a high volatility, which brings a significant loss of the plasticizer during the preparation of the plasticized PLA composition.

Ketals are also described in the application US 2008/0242721 as plasticizers for polymers, including PLA or poly(3-hydroxyalkanoic acid).

Different plasticizers for poly(hydroxyalkanoic acid) are also disclosed in the application WO 02/085983, including paraffin, epoxy compounds, polyols, fatty acid or dicarboxylic acid esters, oils, glycerol esters or phosphates. However, no cyclic diol ester is described as plasticizer in this document.

The document EP 2 143 743 Al describes, for its part, a process for the preparation of resin, in which a 1,4:3,6-dianhydrohexitol ester derivative is used in this process as solvent, co-solvent and/or coalescence agent and not as plasticizer. A mixture comprising a polyester oligomer, which comprises 60 mol % of saturated aliphatic units, of other monomers and oligomers, and also an isosorbide diether: dimethyl isosorbide, is described in table 1. This intermediate mixture is subsequently used for the manufacture of polyurethane.

Thus, none of the current solutions is entirely satisfactory for the plasticization of aliphatic or semi-aliphatic polyesters.

Furthermore, another problem of the products manufactured from these polyesters is the level of sound nuisance which can accompany their use.

This is because, during the handling of the product by the final consumer, the noise created can be very loud, this particularly being the case when said product comprises sheets or films of these polyesters, which are generally the case with packagings.

By way of example, as a result of the dissatisfaction of consumers, Frito Lay® in 2010 had to withdraw bags of chips which they had placed on the American market and which were packaged in material produced from PLA because the noise was too great when the consumer of the chips opened or handled the bag.

Similar problems could also be observed in plants for the manufacture of articles made of PLA, in particular when these objects are obtained by extrusion.

There thus still exists at the current time a need to find novel plasticized compositions based on these polyesters, these compositions exhibiting:
an increased flexibility in comparison with the polyester alone,
a greater strain at break than that of the polyester alone,
a faint odor,
and/or good compatibility of the plasticizer with the polyester, making possible good blending of the plasticizer and polyester during the manufacture and a low, indeed even non-existent, exudation of the plasticizer from a polymer during use.

It is also advantageous to be able to find a composition based on one of these polyesters which makes possible the manufacture of objects for which the handling is not excessively loud, indeed even also to limit sound nuisance during the manufacture of said object.

Furthermore, it is advantageous for the plasticizer used not to volatilize or not to volatilize to any great extent during the manufacture of this composition.

The Applicant Company has discovered, in the context of its research studies targeted at improving the mechanical properties of aliphatic or semi-aliphatic polyesters, that the latter can be advantageously plasticized by certain alkyl esters of dianhydrohexitols and that such a plasticization makes it possible to overcome the disadvantages of the state of the art which are described above.

A subject matter of the invention is thus a composition comprising:
at least one aliphatic or semi-aliphatic polyester, comprising at least 70 mol % of saturated aliphatic units, these units being capable of being obtained by polycondensation of monomers chosen from:
   saturated hydroxyalkanoic acids of formula:

HO—CₓH₂ₓ—COON
saturated dicarboxylic acids of formula:

HOOC—CₓH₂ₓ—COON
and saturated diols of formula:

HO—CₓH₂ₓ—OH,
where x=1-20, preferably 1-6,
the remaining portion of the units being formed by aromatic units;

and
at least one 1,4:3,6-dianhydrohexitol alkyl ester chosen from isosorbide, isomannide and isoidide monoalkyl esters and dialkyl esters.

The use of 1,4:3,6-dianhydrohexitol (and in particular isosorbide) esters as plasticizer for vinyl polymers, cellulose acetate polymers or synthetic rubbers is already known from the patent U.S. Pat. No. 2,387,842, dating from 1944.

Mention may also be made of the paper by Hachihama and Hayashi: Studies on the Preparation of Plasticizers from Carbohydrate Sources (Technol. Repts. Osaka Univ., Vol. 3, 1953), which studies the plasticization of PVC by different isosorbide esters.

More recently, the plasticization of polymers by these 1,4:3,6-dianhydrohexitol esters has also formed the subject matter of the applications WO 99/45060 and US200710282042. Mention may also be made of the application US 2009/0301348, which relates to specific 1,4:3,6-dianhydrohexitol esters obtained from a saturated carboxylic acid comprising 9 carbon atoms: these esters are used as plasticizers in suspensions of PVC or of acrylic polymers.

However, although the 1,4:3,6-dianhydrohexitol ester is known as plasticizer for the polymers mentioned in the above section, this ester has never been used as plasticizer in aliphatic or semi-aliphatic polyesters.

Surprisingly, a 1,4:3,6-dianhydrohexitol alkyl ester makes it possible to very effectively plasticize these specific polyesters, which makes it possible to obtain improved properties in comparison with the plasticized compositions of the prior art based on these polyesters.

The aliphatic or semi-aliphatic polyester capable of being obtained by the polycondensation of saturated hydroxyalkanoic acids of formula HO—CₓH₂ₓ—COOH comprises the following units:

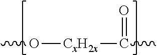

This polyester is also referred to below as poly(hydroxyalkanoic acid) (PHA). It can be chosen from poly(glycolic acid) (PGA), poly(lactic acid) (PLA), poly(3-hydroxypropionic acid) (PHP), poly(2-hydroxybutyric acid) (P2HB), poly(3-hydroxybutyric acid) (PHB), poly(4-hydroxybutyric acid) (P4HB), poly(3-hydroxyvaleric acid) (PHV), poly(4-hydroxyvaleric acid) (P4HV) and poly(5-hydroxyvaleric acid) (P5HV), poly(6-hydroxyhexanoic acid) (also known under the name polycaprolactone (PCL)), poly(3-hydroxyhexanoic acid), poly(4-hydroxyhexanoic acid) or poly(3-hydroxyheptanoic acid). Preferably, the PHA is chosen from PGA, PCL and PLA.

The aliphatic or semi-aliphatic polyester capable of being obtained by the polycondensation of a saturated dicarboxylic acid of formula HOOC—CₓH₂ₓ—COOH and of a saturated diol of formula HO—CₓH₂ₓ—OH comprises the following structure:

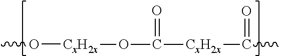

An aliphatic polyester comprising the above structure can be poly(butylene succinate) (PBS), poly(butylene adipate) (PBA), poly(ethylene succinate) or poly(ethylene adipate).

The above polyester structures correspond to polyester homopolymers. However, the polyesters used in the present invention can also be copolymers, that is to say polyesters obtained by a polycondensation of a combination of several diols, diacids and/or hydroxy acids.

Poly(hydroxyalkanoic acid)s (PHA) can, of course, be obtained by direct polymerization of the hydroxyalkanoic acid monomer (for example the glycolic acid for PGA or lactic acid for PLA). This hydroxyalkanoic acid comprises from 2 to 21 carbon atoms.

However, the production of these poly(hydroxyalkanoic acid)s from the hydroxy acids often proves to be difficult due to the water of reaction released and it is often preferable to synthesize these polyesters from cyclic esters and dimeric cyclic esters of hydroxyalkanoic acid, the latter being obtained by a cyclization reaction of two hydroxyalkanoic acids.

Mention may be made, as an example of such monomers, of glycolide (1,4-dioxane-2,5-dione), which is the dimeric cyclic ester of glycolic acid, lactide (3,6-dimethyl-1,4-dioxane-2,5-dione), which is the dimeric cyclic ester of lactic acid, α,α-dimethyl-β-propiolactone, which is the cyclic ester of 2,2-dimethyl-3-hydroxypropanoic acid, β-butyrolactone, which is the cyclic ester of 3-hydroxybutyric acid, δ-valerolactone, which is the cyclic ester of 5-hydroxypentanoic ester, ε-caprolactone, which is the cyclic ester of 6-hydroxyhexanoic acid, or lactones of methyl-substituted derivatives of 6-hydroxyhexanoic acid (such as 2-methyl-6-hydroxyhexanoic acid, 3-methyl-6-hydroxyhexanoic acid, 4-methyl-6-hydroxyhexanoic acid, and the like).

Hydroxyalkanoic acids, except for glycolic acid, exhibit at least one asymmetric carbon and thus exist in enantiomeric forms. Thus, lactic acid exists in the form of D-lactic acid and L-lactic acid. Poly(lactic acid) can be obtained from each of these two more or less pure enantiomers or from a racemic mixture of the two enantiomers. By way of example, the PLA can comprise from 85 to 99.9 mol % of D-lactic acid units and from 1 to 15 mol % of L-lactic acid units.

According to a preferred embodiment of the invention, the aliphatic polyester is a semicrystalline PLA comprising from 90 to 99.9 mol %, preferably from 92 to 99 mol %, of D-lactic acid units and from 0.1 to 10 mol %, preferably from 1 to 8 mol %, of L-lactic acid units. This semicrystalline PLA is in fact particularly brittle where it is not plasticized and its satisfactory plasticization is thus of decisive importance. Despite these poor properties of this highly crystalline PLA, the composition according to the invention obtained from this PLA is, surprisingly, entirely satisfactory for uses requiring a degree of flexibility.

One advantage of these hydroxyalkanoic acids which can be used as monomers for the manufacture of the polyester lies in the fact that they can be manufactured from vegetable raw materials, which will be referred to generally as “renewable raw materials”. As a result of the exhausting of oil resources and environmental problems relating to the consumption of these resources (atmospheric CO₂ re-emission), the polyesters manufactured from renewable raw materials are particularly advantageous.

The saturated diol of use in the formation of the aliphatic or semi-aliphatic polyester comprises from 1 to 20 carbon atoms. It can be chosen from ethylene glycol, 1,2-propanediol, 1,3-propanediol, 1,2-butanediol, 2,3-butanediol, 1,3-butanediol, 1,4-butanediol, 1,5-pentanediol, 1,2-pentanediol or 2-methyl-2,4-pentanediol. The diol is preferably ethylene glycol or 1,4-butanediol.

The saturated dicarboxylic acid of use in the formation of the aliphatic or semi-aliphatic polyester comprises a number of carbon atoms ranging from 3 to 22 carbon atoms, preferably from 3 to 8. It can be chosen from malonic acid, succinic acid, glutaric acid, adipic acid, pimelic acid, suberic acid, azelaic acid and sebacic acid. The dicarboxylic acid is preferably succinic acid or adipic acid.

The aliphatic polyester can be a homopolymer, that is to say a polymer obtained by a polycondensation of just one hydroxyalkanoic acid or of just one diol/dicarboxylic acid pair.

In the other cases, the aliphatic or semi-aliphatic polyester can also be a copolymer, that is to say:
a) a polymer comprising units capable of being obtained by polycondensation of monomers, these monomers comprising at least two different saturated hydroxyalkanoic acids, two different saturated diols and/or two different saturated dicarboxylic acids;
b) and/or a polymer comprising different units from those capable of being obtained by the polycondensation of the monomers described above.

Mention may be made, as example of copolymer a), of the PLA/GA copolymer capable of being obtained from lactic acid and glycolic acid and the PHBV copolymer capable of being obtained from 3-hydroxybutyric acid and 3-hydroxyvaleric acid.

The copolymer b) can comprise at least one aromatic unit obtained by polycondensation of an aromatic monomer, these aromatic units being present in proportions of less than 30 mol %. These aromatic units can be introduced by copolymerization of aromatic dicarboxylic acid, such as terephthalic acid.

The polyester thus formed is then a semi-aliphatic polyester. Mention may be made, as example of semi-aliphatic polyester, of poly(butylene adipate-co-terephthalate) (PBAT), poly(ethylene succinate-co-terephthalate) or poly(butylene succinate-co-adipate-co-terephthalate).

Advantageously, the semi-aliphatic polyester comprises at least 80 mol % of saturated aliphatic units, preferably at least 90%.

The polyester is preferably an aliphatic polyester, that is to say a polyester composed of 100% saturated aliphatic units. It is preferably a poly(C₂₋₇ hydroxyalkanoic acid), in particular a poly(lactic acid).

Advantageously, the polyester of use in the invention has a weight-average molar mass (M_{w}) within the range extending from 3000 to 1 000 000 g/mol, for example from 20 000 to 600 000 g/mol, preferably from 50 000 to 400 000 g/mol. This weight-average mass can be measured by steric exclusion chromatography (GPC, gel permeation chromatography) as polystyrene equivalent according to the standard ISO 16014-1 and the standard ISO 16014-3, using tetrahydrofuran as eluent and a column (polystyrene gel) heated to 40° C.

This aliphatic polyester can be prepared by the processes known to a person skilled in the art. The polycondensation can be carried out in the presence of a catalyst. The processes differ according to the nature of the monomer used.

For example, a first type of process for the dehydration and direct polycondensation of hydroxyalkanoic acid in the presence of solvent and of catalyst (see, for example, the patents U.S. Pat. No. 5,310,865 and U.S. Pat. No. 5,401,796) is used.

Another type of process consists in polymerizing dimeric cyclic esters by ring opening, these dimers having been produced in a prior stage of dehydration of the hydroxyalkanoic acid, such as, for example, in the U.S. Pat. No. 2,703,316.

Block polymers can also be manufactured using the process described in the document EP 712 880.

Fermentation route processes also exist for the manufacture of PHA.

Aliphatic and semi-aliphatic polyesters are available commercially. By way of example, Kureha sells PGA under the Kureflex® brand name. PLAs are also sold by Natureworks under the Ingeo™ brand name or also by Futerro®. PHBV copolymers bearing the Mirel™ brand are also sold by Telles. PCL is also available under the Capa® brand from Solvay. IRe Chemical sells PBS grades (EnPol) and BASF sells PBAT grades under the Ecoflex® brand.

According to an alternative form of the invention, the composition comprises a blend of polyesters of use in the invention: it can be a blend of several polymers of use in the invention. It can, for example, be a blend of PLA and PBAT. BASF sells such blends under the Ecovio® brand (45% by weight PLA and 55% by weight PBAT). The composition can also comprise PLA stereocomplexes, that is to say blends of a first PLA essentially composed of D-lactic acid units and of a second PLA essentially composed of L-lactic acid units.

According to the invention, the 1,4:3,6-dianhydrohexitol alkyl ester makes it possible to plasticize the composition and preferably to make it flexible. 1,4:3,6-Dianhydrohexitol is a diol having the molecular formula C₆H₁₀O₄.

Use is made, according to the invention, of three 1,4:3,6-dianhydrohexitol isomers: isosorbide, isomannide and isoidide, preferably isosorbide.

The 1,4:3,6-dianhydrohexitol alkyl ester is chosen from alkyl monoesters and dialkyl esters.

The alkyl group or groups of the 1,4:3,6-dianhydrohexitol esters are advantageously C₃₋₁₅ alkyl groups, preferably C₄₋₁₀ alkyl groups, in particular C₆₋₉ alkyl groups.

The alkyl group can be a cycloalkyl, linear alkyl or branched alkyl group.

Preferably, the alkyl group is linear or branched, very preferably linear.

This alkyl ester is produced by an esterification reaction of 1,4:3,6-dianhydrohexitol with a carboxylic acid. An esterification reaction can be written in the following way:

R—OH+HO(O)C—R′=>R—O(O)C—R′+H₂O

Thus, if the acid used for the esterification comprises 8 carbon atoms, the alkyl group of the ester is R′ and is thus a C₇ alkyl group.

Mention may be made, as an example of carboxylic acid, of butyric acid, valeric acid, caproic acid, heptanoic acid, caprylic acid, perlargonic acid, nonanoic acid, capric acid, undecanoic acid, lauric acid, tridecanoic acid, myristic acid, pentadecanoic acid, or palmitic acid.

In the case where just one of the two alcohol functional groups of the diol has reacted by esterification, the ester is a monoester. It is a diester in the case where both alcohol functional groups of the diol have reacted in an esterification reaction. The 1,4:3,6-dianhydrohexitol ester is preferably a diester. According to this embodiment, the 1,4:3,6-dianhydrohexitol diester can comprise different alkyl groups, that is to say that the diester is obtained with two different carboxylic acids.

A composition comprising a mixture of 1,4:3,6-dianhydrohexitol esters is of course in accordance with the invention.

The 1,4:3,6-dianhydrohexitol is generally obtained by internal dehydration of a hydrogenated sugar. Isosorbide, isomannide and isoidide can thus be obtained by dehydration of sorbitol, mannitol and iditol respectively.

The synthesis of these dianhydrohexitols is well known: different routes are described, for example, in the papers by Fletcher et al. (1,4,3,6-Hexitoldianhydride, L-isoidide, J. Am. Chem. Soc., 1945, 67, 1042-3, and also 1,4,3,6-Dianhydro-L-iditol and the structure of isomannide and isosorbide, J. Am. Chem. Soc., 1946, 68, 939-41), by Montgomery et al. (Anhydrides of polyhydric alcohols. IV. Constitution of dianhydrosorbitol, J. Chem. Soc., 1946, 390-3, and Anhydrides of polyhydric alcohols. IX. Derivatives of 1,4-anhydrosorbitol from 1,4,3,6-dianhydrosorbitol, J. Chem. Soc., 1948, 237-41), by Flèche et al. (Isosorbide. Preparation, properties and chemistry, Starch/Staerke, 1986, 38, 26-30), by Fukuoka et al. (Catalytic conversion of cellulose into sugar alcohols, Angew. Chem. Int. Ed., 2006, 45, 5161-3), in the U.S. Pat. No. 3,023,223 or also in some of the documents already mentioned relating to the 1,4:3,6-dianhydrohexitol ester.

The isosorbide, isomannide or isoidide ester is obtained by an esterification reaction of the corresponding dianhydrohexitol with a carboxylic acid, as explained above.

For the conditions of the esterification reaction, reference may be made to the documents already mentioned relating to the 1,4:3,6-dianhydrohexitol ester. Use may also be made of the teaching of the application WO2006/103338 on behalf of the Applicant Company.

A mixture of 1,4:3,6-dianhydrohexitol esters can be obtained by simple mixing of different esters obtained by esterification of the 1,4:3,6-dianhydrohexitol.

The mixture can also be obtained by esterification of the 1,4:3,6-dianhydrohexitol with a carboxylic acid mixture.

Another advantage of the compositions of the present invention lies in the fact that the plasticizing agent, that is to say the 1,4:3,6-dianhydrohexitol alkyl ester, can be manufactured from renewable resources, it being possible for the dianhydrohexitol and the carboxylic acid to be obtained from renewable resources.

The 1,4:3,6-dianhydrohexitol alkyl ester is present in the compositions according to the invention in amounts within the range extending from 1 to 30% by weight, with respect to the total weight of aliphatic and semi-aliphatic polyesters.

This amount of 1,4:3,6-dianhydrohexitol ester is advantageously within the range extending from 10 to 25% by weight, preferably from 11 to 20% by weight, and even from 12 to 18% by weight, for example from 13 to 18% by weight, with respect to the total weight of aliphatic and semi-aliphatic polyesters. In the latter ranges, the plasticizing effect of the 1,4:3,6-dianhydrohexitol ester is very particularly significant, in particular when it is used as sole plasticizer in the composition. The flexibility of the composition is greatly increased in comparison with the aliphatic or semi-aliphatic polyester alone and the exudation of the plasticizer out of the polymer after manufacture is very low, even non-existent. This effect is particularly significant and advantageous when the aliphatic polyester is a semicrystalline PLA.

According to one embodiment of the invention, the composition additionally comprises another plasticizer, that is to say a plasticizer other than the 1,4:3,6-dianhydrohexitol alkyl ester. Mention may be made, by way of example, of polypropyleneglycol, which is optionally epoxidized, polyethylene glycol, fatty acids which are partially esterified or glucose monoesters, citrates, adipates, epoxidized soybean oil, acetylated coconut oil, optionally epoxidized linseed oil, phthalates, trimellitates and hydroxyalkanoic acids.

Preferably, the 1,4:3,6-dianhydrohexitol ester/other plasticizer ratio is within the range extending from 50:50 to 100:0, very preferably extending from 80:20 to 100:0.

The composition can furthermore comprise an additional polymer other than the aliphatic or semi-aliphatic polyester, such as, for example, a polyamide or a polyolefin. Preferably, the aliphatic polyester and/or semi-aliphatic polyester/additional polymer ratio is within the range extending from 50:50 to 100:0, very preferably extending from 80:20 to 100:0.

This additional polymer can have the role of impact modifier, that is to say that it makes it possible to improve the impact behavior of the composition. By way of example, this impact modifier can be an ethylene copolymer, such as, for example, one of those described in the application US 2005/0131120 A1, in sections [0017] to [0022].

According to one embodiment of the compositions according to the invention, the polymer of the composition is essentially composed of at least one aliphatic or semi-aliphatic polyester, that is to say that the composition comprises at most 5% by weight of additional polymer, with respect to the total weight of aliphatic or semi-aliphatic polyesters. The compositions according to the invention preferably comprise, as sole organic polymer, the aliphatic or semi-aliphatic polyesters described above.

The composition can furthermore comprise other additives normal in the manufacture of thermoplastics which are capable of improving at least one of the final properties of the composition and/or of facilitating the process for the manufacture of said composition.

The normal additive examples can be chosen from antioxidants, stabilizers, UV absorbers, antistatic agents, optical brighteners, dyes or pigments, nucleating agents, flame retardants, lubricants, antiblocking agents, mold-release agents, anticaking agents, antimicrobials, anti-fogging agents and blowing agents. The composition can comprise, as normal additives, in addition to the polyester and plasticizer, reinforcements or fillers, for example natural vegetable fibers, such as wood sawdust, wood fibers or hemp fibers.

This particular composition exhibits a good thermomechanical behavior.

Preferably, these normal additives are present in amounts not exceeding 30% by weight of the composition, preferably not exceeding 20% by weight of the composition.

According to an alternative form of the invention, the composition comprises, with respect to the total weight of the composition:
from 40 to 99% by weight of aliphatic or semi-aliphatic polyester, advantageously from 45 to 89% and preferably from 50 to 88%;
from 1 to 30% by weight of 1,4:3,6-dianhydrohexitol ester, advantageously from 11 to 25%, preferably from 12 to 20%;
from 0 to 30% by weight of additional polymer;
from 0 to 30% of another plasticizer and/or additives normal in the manufacture of the thermoplastics.

One way of determining if the aliphatic or semi-aliphatic polyester is plasticized by the 1,4:3,6-dianhydrohexitol ester is to compare the glass transition temperature of the polyester/plasticizer blend (T_{g}1) with the glass transition temperature of the polyester alone (T_{g}2). If T_{g}1 is less than T_{g}2, the polyester can be regarded as plasticized.

Preferably, the composition is such that T_{g}1<(T_{g}2−5), indeed even T_{g}1<(T_{g}2−10), for example T_{g}1<(T_{g}2−20), in other words the incorporation of the plasticizer in the aliphatic or semi-aliphatic polyester is reflected by a reduction in the glass transition temperature of greater than 5° C., preferably of greater than 10° C. and in particular of greater than 20° C.

The PLA plasticized according to the invention by a 1,4:3,6-dianhydrohexitol alkyl ester preferably has a Tg of approximately 40° C.

When the polyester is a block copolymer, it is possible for the polyester to exhibit several glass transition temperatures. In this case, this polyester copolymer is regarded as plasticized when at least one of its glass transition temperatures decreases.

The T_{g} can be measured in a known way by differential scanning calometry (DSC) with a heating rate of 10° C./minute: this measurement can be carried out by performing a first heating of the sample, a cooling down to a temperature below the glass transition temperature of the polymer and then a second heating of the sample during which the glass transition temperature is measured, the heating and cooling rates being 10° C./minute.

Typically, the following protocol is used:
1st heating from −120 to 220° C. at 10° C./min;
cooling from 220 to −120° C. at 10° C./min;
2nd heating from −120 to 220° C. at 10° C./min.

As explained above, some aliphatic or semi-aliphatic polyesters, such as PLA or PGA, are very brittle. It is therefore advantageous to sufficiently “plasticize” them in order to modify the mechanical properties thereof and to thus make it possible to use them in more diverse applications.

Thus, the elongation at break of the composition is advantageously greater than or equal to 100%, indeed even greater than or equal to 500%. This elongation at break can be measured according to the standard EN ISO 527-1:1996.

Another subject matter of the invention is a process for the preparation of the composition according to the invention, comprising a step of melt blending the aliphatic or semi-aliphatic polyester with the other constituents of the composition.

Use may be made of the equipment known to a person skilled in the art of processing thermoplastics which are temperature regulated, such as mixers or extruders. For example, use may be made of any type of processing equipment, such as an extruder, a kneader, an internal mixer or an external mixer, such as a roll mixer.

Another subject matter of the invention is a process for the manufacture of a composition according to the invention, comprising a step of blending by extrusion of the aliphatic or semi-aliphatic polyester with the 1,4:3,6-dianhydrohexitol alkyl ester using an extruder.

The process is carried out, for example, using a corotating twin-screw extruder, a counter-rotating twin-screw extruder or a single-screw extruder, preferably using a corotating twin-screw extruder.

The temperature of the processing equipment used is adjusted to the nature of the polyester introduced. This temperature is advantageously within the range extending from 80 to 200° C., which makes it possible to retain the plasticizing properties of the 1,4:3,6-dianhydrohexitol ester. Furthermore, the 1,4:3,6-dianhydrohexitol alkyl ester is not volatile and does not evaporate within this temperature range, in contrast to many other known plasticizers.

The temperature is preferably within the range extending from 130 to 180° C. for the PLA-based compositions.

The composition can be prepared in a single step, that is to say that the constituents are introduced simultaneously, or in several steps, that is to say that the constituents are introduced successively, for example at different points of the extruder.

Preferably, the process for the manufacture of the composition according to the invention comprises:
a step of introduction of the 1,4:3,6-dianhydrohexitol ester into a corotating twin-screw extruder using a first metering device;
a step of introduction of the polyester using a second metering device located further along the extruder;
a step of blending the constituents of the composition in the blending zone of the extruder;
a step of recovery of the composition thus formed.

Excellent homogenization of the 1,4:3,6-dianhydrohexitol ester in the composition is obtained according to this process. The noise during the extrusion can thus be particularly restricted by using this process.

The manufacturing process comprising a step of blending by extrusion can be used for the manufacture of an extruded article, such as granules or profiled elements. The process for the manufacture of this article, which comprises a step of melt blending by extrusion, can also be followed by a step of forming this melt blend by molding, injection molding, spinning or blow molding in order to respectively form a molded, injection molded, spun or blow molded article.

The invention thus relates to any type of extruded, molded, injection molded, spun or blow molded article comprising the composition according to the invention.

This article can be in the form of yarn, of rods, of granules, of sheet or any type of three dimensional object.

Granules can be obtained by granulation of rods obtained by extrusion of the composition.

A sheet of the composition according to the invention can be obtained by extrusion with a flat die at the extruder end. The sheet thus obtained can subsequently be calendered in order to obtain a uniform thickness all along the sheet. It is specified that the term “sheet” includes here a sheet of any thickness and can in particular be a film comprising the composition according to the invention.

This sheet can be monolayer or multilayer, that is to say can comprise a first layer with a composition according to the invention and at least one second layer with a composition different from the first.

The second layer can be manufactured from a composition comprising a polymer (for example a polyester, a polyolefin, a polyamide, and the like), a metal, a metal oxide or a silicon oxide.

These multilayer sheets can be manufactured by coextrusion of the different layers with a flat die, by extrusion coating or by extrusion lamination.

A detailed description of the different layers which can be used in the multilayer sheet appears in sections [0037] to [0054] of the patent application US2008/0071008 A1.

The composition according to the invention can be used for the manufacture of packagings or containers, such as a film, a cup, a lid, a pot, a bag, a bottle, a punnet, a cap or a stopper.

The monolayer or multilayer sheets are of particular use as intermediates in the manufacture of said packagings or containers by thermoforming said sheets.

The composition is also of use in the manufacture of woven and nonwoven textiles. It can also be of use in the manufacture of diapers for babies or feminine hygiene products.

The composition can also be used for the manufacture of adhesives, in particular hot-melt adhesives similar to those described in the U.S. Pat. No. 5,252,646, with the difference that the composition according to the invention comprises the 1,4:3,6-dianhydrohexitol alkyl ester of use in the invention. In order to form an adhesive, the composition can also comprise waxes having the role of increasing the open time for application of the adhesive, such as microcrystalline waxes, fatty amide waxes and oxidized Fischer-Tropsch waxes. The composition can also comprise tackifying resins which make it possible to improve the “tack” of the adhesive, such as rosins, rosin derivatives, terpenes or modified terpenes. It is specified that the waxes and the tackifying resins are polymers.

Another application of the composition according to the invention is the manufacture of products of use in the medical field, for example yarns for stitching wounds, stents, dialysis devices or medicine dispensing devices.

Another subject matter of the invention is the use of a 1,4:3,6-dianhydrohexitol alkyl ester chosen from isosorbide, isomannide and isoidide monoalkyl esters and dialkyl esters in the plasticization of an aliphatic or semi-aliphatic polyester as described above. The different preferred forms relating to the composition of the invention set out in this patent application can, of course, be adapted to this use of the 1,4:3,6-dianhydrohexitol alkyl ester in the plasticization of an aliphatic or semi-aliphatic polyester.

Embodiments will now be described in detail in the following examples. It is specified that these illustrative examples do not in any way limit the scope of the present invention.

### EXAMPLES

### Example 1

### Plasticization of the Aliphatic and Semi-Aliphatic Polymers: Sensory Evaluation and Change in the Glass Transition Temperature

Products Used

Polymers Used
PLA 1: Poly(lactic acid), grade 6302D (NatureWorks), Mw=170 000 g/mol
PCL: Polycaprolactone, Capa® 650 (Solvay)
PBAT: Poly(butylene adipate terephthalate), Ecoflex FBX 7011 (BASF)
PBS: Poly(butylene succinate), EnPol G4560J (IRe Chemical)
PET: Poly(ethylene terephthalate), Lighter C93 (Equipolymers)
PBT: Poly(butylene terephthalate), Valox 325F (Sabic)
PS: Crystal polystyrene, PS 500 (Sabic)

Plasticizers:
IDE (plasticizer used in the invention): isosorbide dialkyl ester (C₇ alkyl groups)
DINP: Diisononyl phthalate (Sigma-Aldrich)
Jayflex Dina Z: Diisononyl adipate (Exxon-Mobil)
Diplast TM ST: Trimellitate (Polynt)

Preparation of the Compositions

A Rheomix 600 (Haake) kneader with a capacity of 120 cm³ equipped with cylindrical rotors is used to prepare these compositions. The polymer and the plasticizer are introduced at an initial temperature of 50° C., the speed of the rotors being 80 revolutions/min. The blend comprises, by weight, 80% of polymer and 20% of plasticizer. The temperature is gradually raised over a period of time of 5 minutes up to the processing temperature of the product (PT) and then the blend is homogenized at this temperature for 10 minutes at the PT.

After having collected the plasticized polymer, it is formed, using a heating press (Carver), into the form of films with a thickness of approximately 150 microns (under a pressure of 20 tonnes for 3 minutes at the PT).

It is evaluated, on the films, if the plasticizer introduces, to the touch, a plasticization, namely an increase in the flexibility and the ability to be drawn. The good compatibility of the plasticizer with the polyester is also confirmed. This compatibility is reflected by a low exudation, indeed even by the absence of exudation.

The results obtained for the blends of PLA and different plasticizers appear in table 1. The PT for the PLA is 150° C.

TABLE 1
Sensory evaluation of the plasticization of PLA1 by different plasticizers

| | | Plasticizing |
|---|---|---|
| Plasticizer | Exudation | effect on film |
| DINP | no | no |
| Jayflex Dina-Z | no | no |
| Diplast TM/ST | yes | no |
| IDE | no | yes |

It could be noted that IDE gives a plasticizing effect with regard to PLA both as concerns the ability to be drawn and the flexibility. Furthermore, it appears compatible with PLA as no exudation is observed.

In contrast, the known plasticizers for PVC do not show a plasticizing effect on the films, indeed even sometimes exude from the polymer.

Blends of the different polymers used with IDE are also produced according to the protocol set out above. The results obtained appear in table 2.

TABLE 2
Sensory evaluation of the plasticization of different polyesters by IDE

| | | | Plasticizing |
|---|---|---|---|
| Polymer | PT | Exudation | effect on film |
| PLA | 150° C. | no | yes |
| PCL | 100° C. | no | yes |
| PBAT | 170° C. | yes (slight) | yes |
| PBS | 150° C. | no | yes |

It may be noted that the plasticizing effect observed for PLA is also observed for PCL and PBS.

The compositions based on PET, on PBT (other than the aliphatic and semi-aliphatic polyesters used in the invention) or on PS do not appear in the table: plasticization of the polymer is not observed and decomposition of the material is observed, which decomposition is related to a thermal decomposition of the plasticizer due to an excessively high PT (greater than 220° C.).

The plasticizing effect is also observed for PBAT, which is a semi-aliphatic polyester. However, a slight exudation is observed, showing that these aromatic polyesters are slightly less compatible with IDE.

Blends of PLA and of IDE are produced using the same protocol as above, using amounts of IDE ranging from 5% to 12.5% by weight. The glass transition of the PLA or of the blends is measured by DSC (Mettler Toledo) using the following protocol:
1st heating from −120 to 220° C. at 10° C./min;
cooling from 220 to −120° C. at 10° C./min;
2nd heating from −120 to 220° C. at 10° C./min.

The glass transition temperature given in table 3 is the temperature observed during the 2nd heating.

TABLE 3
Change in the T_{g} of the PLA as a function of the content of IDE incorporated

| | Content of plasticizing | Tg measured in the |
|---|---|---|
| PLA | agent (IDE) | second heating (° C.) |
| 6320 | 0% | 54 |
| | 5% | 46 |
| | 10% | 39 |
| | 12.5% | 34 |

Plasticization is observed from the low levels of IDE, as is shown by the lowering in the glass transition temperature of the product at 5%. The plasticization is improved by increasing the content of IDE.

### Example 2

### Plasticization of PLA: Determination of the Mechanical Properties

Products Used
Polymer used
PLA 2: Poly(lactic acid), grade 3051 D (NatureWorks), Mw=95 000 g/mol
Plasticizers:
IDE (plasticizer used in the invention): Isosorbide di(C₇)ester;
PEG 400: Polyethylene glycol with a molecular weight of 400 g/mol (Sigma-Aldrich);
Triacetin (Sigma-Aldrich).

Preparation of the Compositions

Use is made, in preparing these compositions, of a TSA EMP 26-40 corotating twin-screw extruder (TSA Industriale Srl), the extrusion being carried out with a die with a diameter of 3 cm.

The different plasticizers are blended with the PLA in proportions by weight of table 4.

The preparation conditions are as follows:
Temperature profile: 170° C. (for the 8 heating zones)
Die head temperature: 170° C.
Introduction of the plasticizer via a metering pump into the inlet zone and then introduction of the polymer into zone 3 via a side feeder
Screw speed: 200 rev/min
Flow rate: 5 kg/h.

It could be found that the use of IDE with the PLA makes it possible to reduce the noise during the extrusion of the PLA.

After having collected the cooled rods and after having cut up into granules, the products are subsequently injection molded on a Carver injection molding machine in the form of tension and bending test specimens under the following conditions:
Temperature of barrels: 160/160/160
Rotational speed of the screw=280 rev/min
Cycle time: 1 to 2 min
Temperature of the mold: 5 to 20° C.
Hold pressure=100 kpsi/cm²

These test specimens are subsequently characterized in tension according to the standard EN ISO 527-1:1996 (elongation at break and tensile strength) and in bending according to the standard NF EN ISO 178:2003-05 (rigidity modulus).

The granules are also characterized in DSC in order to measure the glass transition according to a protocol identical to that of example 1.

All the properties modified by the plasticization, namely the lowering in the rigidity modulus and in the tensile strength, the increase in the elongation at break and the decrease in the glass transition temperature, are presented in table 4 below for each composition tested.

TABLE 4
Effect of the incorporation of the plasticizer on the
mechanical properties and the glass transition temperature of PLA

| | | Young's flexural | Elongation | Tensile | Tg |
|---|---|---|---|---|---|
| PLA | Plasticizer | modulus | at break | strength | (2nd |
| grade | content | (MPa) | (%) | (Mpa) | heating) |
| 3051D | 0% | 3602.1 | 19.9 | 61.5 | 58 |
| | 12.5% IDE | 1878.2 | 420.6 | 21.0 | 35 |
| | 14% IDE | 1239.7 | 595.3 | 29.8 | 32 |
| | 10% PEG | 1948.7 | 395.8 | 23.5 | 34 and −77 |
| | 400 | | | | |
| | 10% | 2409.2 | 15.9 | 40.1 | 35 |
| | Triacetin | | | | |

It is possible to observe, with regard to the IDE-based PLA compositions, significant properties of plasticization of the IDE with regard to the PLA since:
the flexural modulus is decreased by half at 12.5-14% of IDE with respect to the pure PLA;
ability to be drawn: the elongation at break changes from 20% (i.e., a very brittle plastic) to very high levels (from 400 to 600%);
a decrease by approximately a factor of 2 to 3 in the tensile strength.

These modifications to mechanical properties are correlated with the lowering in the glass transition of the PLA.

When the compositions based on IDE and based on other recognized plasticizers of PLA (PEG 400 or triacetin) are compared, it may be noted that:
the plasticizer power of triacetin is markedly poorer than that of IDE since the brittle nature of the product (low elongation at break) is retained;
the plasticizer power of PEG 400 is comparable to and at the same order of magnitude as that of IDE.

However, contrary to IDE, the compositions based on triacetin and of PEG 400 are not satisfactory from the viewpoint of the compatibility of the plasticizer with PLA, even at degrees of incorporation of 10% by weight. This is because we were able to observe:
a significant exudation during the extrusion of the product from the phase of preparation for triacetin;
a DSC signal corresponding to the glass transition temperature of pure PEG 400 (T_{g} at −77° C.), the sign of a separate PEG phase, that is to say of a lack of compatibility of the PEG with the PLA.

### Example 3

### Plasticization of Aliphatic and Semi-Aliphatic/Semi-Aromatic Polyester Blends: Determination of the Mechanical Properties

Products Used
Blend of polyesters: Ecovio® (BASF), consisting of a blend of PBAT (55% by weight) and of PLA (45% by weight);
IDE (plasticizer used in the invention): isosorbide di(C₇)ester.

The compositions are prepared according to the same protocol as that of example 2. In the same way, the properties are measured using the same measurement conditions as example 2.

The properties obtained for the blends of polyester with IDE are presented in table 5.

TABLE 5
Effect of the incorporation of a plasticizer on the mechanical
properties and the glass transition temperature of the blends of polyesters

| | Young's | Elongation | Tensile | |
|---|---|---|---|---|
| Plasticizer | flexural | at | strength | Tg |
| content | modulus (MPa) | break (%) | (Mpa) | (2nd heating) |
| 0% | 1100.23 | 403.36 | 20.9 | −34° C. and 56° C. |
| 12.5% IDE | 464.30 | 655.08 | 17.11 | −40° C. and 40° C. |

These tests show that IDE indeed has a plasticizing effect on the blends of polyesters:
The incorporation of 14% of IDE decreases the flexural modulus by a factor of 4 with respect to the plasticizer-free blend.
The addition of IDE significantly increases the elongation at break.

These modifications to mechanical properties are confirmed by the decreases observed in the glass transition temperatures of PBAT and PLA.

### Example 4

### Measurement of the Noise of PLA Films

Products

PLA 3: Poly(lactic acid), grade 2002D (NatureWorks), Mw=200 000 g/mol IDE (Plasticizer used in the invention)

A Rheomix 600 (Haake) kneader with a capacity of 120 cm³ and equipped with cylindrical rotors is used to prepare these compositions. The polymer and the plasticizer are introduced at an initial temperature of 50° C., the speed of the rotors being 80 revolutions/min. The blend comprises, by weight, 80% PLA and 15% or 20% of plasticizer. The temperature is gradually raised over a period of time of 5 minutes up to a temperature of 170° C. and then the blend is homogenized at this temperature for 15 minutes.

After having collected the plasticized polymer, it is formed using a heating press (Carver) into the form of films with a thickness of approximately 180 microns (under a pressure of 20 tonnes for 3 minutes at 170° C.).

Conditions for the implementation of the test:

The films obtained above are crumpled manually in an identical way and the noise of the crumpling is measured using a sound level meter, of B&K brand, type 2232, at a distance between the measurement probe and the crumpled film of 10 cm, that is to say a distance very close to the film.

The results obtained are as follows:

| | | Distance of the | | Sound |
|---|---|---|---|---|
| | | measurement | Thickness | levels in |
| Compositions | Method | probe | (mm) | dB(A) |
| PLA 2002D, pure | Crumpling | at 10 cm | 0.18 | 91 |
| PLA 2002D + 15% IDE | | | 0.18 | 87 |
| PLA 2002D + 20% IDE | | | 0.17 | 82 |

It is observed that the use of IDE greatly reduces the noise given off when the film is crumpled. This is because a decrease of 3 dB is equivalent to a decrease in the noise of half. The use of 15% of IDE thus makes it possible to divide by two the noise given off by the film. Furthermore, by increasing the content of plasticizer from 15% to 20%, the sound intensity of the crumpling is reduced by a factor of 8 with respect to the noise given off by a film of pure PLA (decrease of 9 dB).

1-18. (canceled)

19. A composition comprising:
at least one aliphatic or semi-aliphatic polyester, comprising at least 70 mol % of saturated aliphatic units, these units being capable of being obtained by polycondensation of monomers chosen from:
saturated hydroxyalkanoic acids of formula:
HO—CₓH₂ₓ—COOH,
saturated dicarboxylic acids of formula:
HOOC—CₓH₂ₓ—COOH and
saturated diols of formula:
HO—CₓH₂ₓ—OH
where x=1-20, preferably 1-6,
the remaining portion of the units being formed by aromatic units;
and
at least one 1,4:3,6-dianhydrohexitol alkyl ester chosen from isosorbide, isomannide and isoidide monoalkyl esters and dialkyl esters.

20. The composition as claimed in claim 19, wherein the alkyl group or groups of the 1,4:3,6-dianhydrohexitol esters are C₃₋₁₅ alkyl groups, preferably C₄₋₁₀ alkyl groups, in particular C₆₋₉ alkyl groups.

21. The composition as claimed in claim 19, wherein the alkyl group of the 1,4:3,6-dianhydrohexitol ester is linear or branched.

22. The composition as claimed in claim 19, wherein the amount of 1,4:3,6-dianhydrohexitol alkyl ester is within the range extending from 1 to 30% by weight, with respect to the total weight of aliphatic and semi-aliphatic polyesters.

23. The composition as claimed in claim 19, wherein the amount of 1,4:3,6-dianhydrohexitol alkyl ester is within the range extending from 10 to 25% by weight, advantageously from 11 to 20% by weight, preferably from 12 to 18% by weight, with respect to the total weight of aliphatic and semi-aliphatic polyesters.

24. The composition as claimed in claim 19, wherein the 1,4:3,6-dianhydrohexitol alkyl ester is a 1,4:3,6-dianhydrohexitol dialkyl ester.

25. The composition as claimed in claim 19, wherein the 1,4:3,6-dianhydrohexitol ester is an isosorbide alkyl ester, preferably an isosorbide dialkyl ester.

26. The composition as claimed in claim 19, wherein the aliphatic or semi-aliphatic polyester comprises at least 80 mol %, preferably at least 90 mol %, of saturated aliphatic units.

27. The composition as claimed in claim 19, wherein the polyester is composed of 100% of saturated aliphatic units.

28. The composition as claimed in claim 19, wherein the polyester is chosen from the group consisting of poly(glycolic acid) (PGA), poly(lactic acid) (PLA), poly(3-hydroxypropionic acid) (PHP), poly(2-hydroxybutyric acid) (P2HB), poly(3-hydroxybutyric acid) (PHB), poly(4-hydroxybutyric acid) (P4HB), poly(3-hydroxyvaleric acid) (PHV), poly(4-hydroxyvaleric acid) (P4HV), poly(5-hydroxyvaleric acid) (P5HV), polycaprolactone (PCL), poly(3-hydroxyhexanoic acid), poly(4-hydroxyhexanoic acid), poly(3-hydroxyheptanoic acid), poly(butylene succinate) (PBS), poly(butylene adipate) (PBA), poly(ethylene succinate) and poly(ethylene adipate), preferably from the group consisting of poly(glycolic acid) (PGA), poly(lactic acid) (PLA), polycaprolactone (PCL) and poly(butylene succinate) (PBS).

29. The composition as claimed in claim 27, wherein the aliphatic polyester is a poly(C₂₋₇ hydroxyalkanoic acid), preferably a poly(lactic acid).

30. The composition as claimed in claim 28, wherein the aliphatic polyester is a semicrystalline poly(lactic acid) comprising from 90 to 99.9 mol % of D-lactic acid units and from 0.1 to 10% of L-lactic acid units.

31. A process for the manufacture of a composition as claimed in claim 19, comprising a step of blending by extrusion of the aliphatic or semi-aliphatic polyester with the 1,4:3,6-dianhydrohexitol alkyl ester using an extruder, preferably a corotating twin-screw extruder.

32. The manufacturing process as claimed in claim 30, wherein the temperature of the extruder used during the blending is within the range extending from 80 to 200° C.

33. An extruded, molded, injection molded, spun or blow molded article comprising the composition as claimed in claim 19.

34. The article as claimed in claim 32, said article being a yarn, a granule, a sheet or a three-dimensional object.

35. Packagings, containers, woven and nonwoven textiles, diapers for babies, feminine hygiene products, adhesives or products of use in the medical field manufactured from the composition as claim in claim 19.

36. The packagings, containers, woven and nonwoven textiles, diapers for babies, feminine hygiene products, adhesives or products of use in the medical field as claimed in claim 34, wherein 1,4:3,6-dianhydrohexitol alkyl ester is chosen from isosorbide, isomannide and isoidide monoalkyl esters and dialkyl esters in the plasticization of an aliphatic or semi-aliphatic polyester comprising at least 70 mol % of saturated aliphatic units, these units being capable of being obtained by the polycondensation of monomers chosen from:
saturated hydroxyalkanoic acids of formula:
HO—CₓH₂ₓ—COOH
saturated dicarboxylic acids of formula:
HOOC—CₓH₂ₓ—COOH
and saturated diols of formula:
HO—CₓH₂ₓ—OH,
where x=1-20, preferably 1-6,
the remaining portion of the units being formed by aromatic units.
